(19) United States
(12) Patent Application Publication
(10) Pub. No.: US 2007/0013781 A1
(43) Pub. Date: Jan. 18, 2007

(54) Digital camera with automatic operating mode selection

(75) Inventors: Naohiro Kageyama, Sakai-shi (JP); Yasuhiko Takeda, Izumi-shi (JP); Yoko Sogabe, Sakai-shi (JP); Katsuyuki Nanba, Sakai-shi (JP)

Correspondence Address: SIDLEY AUSTIN LLP, 717 NORTH HARWOOD, SUITE 3400, DALLAS, TX, 75201, US

(73) Assignee: MINOLTA CO., LTD.

(21) Appl. No.: 11/522,765

(22) Filed: Sep. 18, 2006

Related U.S. Application Data
(62) Division of application No. 09/047,676, filed on Mar. 25, 1998.

(30) Foreign Application Priority Data
Mar. 25, 1997 (JP) H9-072017
Mar. 25, 1997 (JP) H9-072027

(51) Int. Cl. H04N 5/225

(52) U.S. Cl. 348/207.2

(57) ABSTRACT

An electronic still camera which transmits taken images to a printer connected to the camera to print the images is provided with a microcomputer for generating image data for printing and communicating with the printer. When start of printing is directed, the microcomputer obtains information on characteristics of the printer from the printer, generates image data whose number of pixels differs between when the printing density is a predetermined value or more and when it is less than the predetermined value, and transmits the image data to the printer. A connector is provided for attaching a cable of the printer to the electronic still camera, and a switch for detecting whether the cable is attached or not is provided in the connector. When the cable is attached to the connector, only transmitting images to the printer to print the images is permitted even if taking of images or reproduction display is directed by a manual operation.

This application is a divisional application of application Ser. No. 09/047,676, filed Mar. 25, 1998, which is based on applications Nos. H9-072017 and H9-072027 filed in Japan, the contents of which are hereby incorporated by reference.

### BACKGROUND OF THE INVENTION

1. Field of the Invention

The present invention relates to an electronic still camera, and more specifically, to an electronic still camera which transmits taken images to an external apparatus.

2. Description of the Prior Art

In an electronic still camera, taken images are stored in a flash memory or a memory card, and the stored images are reproduced and displayed on a display device provided on the camera. Typically, the electronic still camera is not provided with a printer, and to preserve images, the images are transmitted to an external printer and printed by the printer.

The printers are available in various models ranging from a simple one with low resolution to a high-performance printer with high resolution, and the printer which can be connected to the electronic still camera is not limited to one model. The user can obtain printed images of desired resolution by selecting a printer according to the usage. When image printing is directed, the electronic still camera reads out stored images, generates image data for printing by a predetermined procedure and transmits the image data to the connected printer.

Such an electronic still camera has a connector for attaching a cable for connecting the camera and the printer, and is provided with an operation member such as a dial for switching among operation modes of photographing, reproduction and printing. The user performs switching between the operation modes by a manual operation to thereby perform photographing and reproduction with only the camera, and when printing is performed, the user attaches the cable to the connector, connects a printer and switches the operation mode to the printing mode by a manual operation.

In recent years, it has been performed to transmit images from the electronic still camera to a personal computer so that various processings such as image printing, display, storage, retouch and superimposition are performed by the personal computer. The electronic still camera generates image data by a predetermined procedure also when images are transmitted to a personal computer.

However, conventional electronic still cameras are disadvantageous in the time required for printing and the quality of the printed images because image data for printing are always generated by a predetermined procedure irrespective of the characteristics of the connected printer. Before performing image printing, the printer thins out the image data when supplied with image data of a higher resolution than the printing resolution of the printer, and interpolates the image data when supplied with image data of a lower resolution than the printing resolution of the printer.

The image data discarded in the thinning out are essentially unnecessary for image printing and the transmission of the needless image data naturally increases the time required for transmission. When image data of a lower resolution are transmitted, although no time is wasted in transmission, the quality of the printed images is poor compared with that when image data of a higher resolution are supplied, because high-resolution taken images cannot be reproduced even though the interpolation is performed.

For this reason, according to the conventional electronic still came for cameras generating high-resolution image data, printing requires a long time although the resolution of the printed images is low when a simple printer is used, and for cameras generating low-resolution image data, the performance of the printer cannot be fully delivered even if a high-performance printer is used. For cameras generating image data of intermediate resolution, both of these problems arise.

These problems arise not only when images are transmitted to a printer but also when images are transmitted to other apparatus such as a personal computer, and unnecessarily long time is required from the start of transmission to the completion of reception and the quality of images reproduced and stored by the external apparatus degrades.

Moreover, according to the conventional electronic still cameras, in order to transmit images to an external apparatus such as a printer or a personal computer, it is necessary to perform both the operation of attaching the cable and the operation of switching the operation mode, and after printing is completed and the cable is detached from the connector, it is necessary to return the operation mode to the photographing or the reproduction mode by a manual operation. Such operations are inconvenient to the user and reduce the ease-of-use of the camera. In addition, when the user forgets to return the mode, there is a possibility that the right moment to take a picture is missed in the next photographing.

### SUMMARY OF THE INVENTION

An object of the present invention is to provide an electronic still camera which can transmit image data very efficiently to an external apparatus such as a printer and make the most of the performance of the external apparatus. A further object of the present invention is to provide an electronic still camera of excellent operability which requires minimal user's operations to transmit image data to an external apparatus.

To achieve the above-mentioned objects, according to one aspect of the present invention, a camera having an output section for outputting image data representative of a taken image to an external apparatus comprises a communicator for communicating with the external apparatus, and an image processor for generating image data to be outputted to the external apparatus based on a characteristic of the external apparatus obtained through the communication. The characteristic of the external apparatus obtained through the communication is, for example, a resolution, and the external apparatus is, for example, a printer for printing an image represented by the image data.

By configuring the image processor so as to generate the image data to be transmitted in accordance with the resolution of the external apparatus, generation of image data of too high resolution for the external apparatus to make use of, and image data of too low resolution for the external apparatus to take full advantage of its own resolution can be avoided. When image data are transmitted to a printer, by generating image data in accordance with the characteristics of the printer, printed images in which the performance of the printer is fully delivered are obtained in an appropriate time commensurate with the quality of the images.

According to another aspect of the present invention, a camera being operable in a first mode in which photographing of a subject is performed and data of a taken image are stored, in a second mode in which an image of the stored data is displayed, and in a third mode in which the stored data are outputted to a printer through a detachably attached connection device and an image of the data is printed, comprises a manual operation member, a selector for switching between the first mode and the second mode by an operation of the manual operation member, a connector for attaching the connection device, and a detector for detecting whether the connection device is attached to the connector or not. Here, the selector selects the third mode irrespective of condition of the manual operation member when it is detected that the connection device is attached.

The user switches between the first and the second modes by a manual operation to perform taking of images or reproduction and display of images, and when the connection device is attached to the connector, the camera is forcibly placed in the third mode by the selector even when the camera is in the first or the second mode. When the user directs start of printing in this mode, image printing is performed by the external printer, and after printing is finished, by detaching the connection device from the connector, the camera is returned to the first or the second mode which the camera had been in before the connection device was attached to the connector.

According to still another aspect of the present invention, a camera which stores data of a taken image and outputs the stored image data to an external apparatus through a detachably attached connection device comprises a connector for attaching the connection device, a detector for detecting whether the connection device is attached to the connector or not, and a controller for permitting the image data to be outputted through the connector when it is detected that the connection device is attached, and inhibiting the image data from being outputted through the connector when it is detected that the connection device is not attached to the connector.

The output of the image data to the external apparatus is permitted only when the connection device is attached to the connector. Therefore, image data can be transmitted to the external apparatus at any given time while the connection device is attached, and when the connection device is not attached, [i.e.] i.e., when the camera is not connected to the external apparatus, the meaningless operation of outputting the image data is inhibited.

### DESCRIPTION OF THE DRAWINGS

These and other objects and features of this invention will become clear from the following description, taken in conjunction with the preferred embodiments with reference to the accompanied drawings in which:

FIG. 1 is a perspective view showing the appearance of an electronic still camera according to first and second embodiments;

FIG. 2 is a block diagram schematically showing the configuration of the electronic still camera according to the first embodiment;

FIG. 3 shows a relationship between switch setting and operation modes in the electronic still camera according to the first embodiment;

FIG. 4 shows a relationship between the printing density of a printer connected to the electronic still camera according to the first embodiment and the number of pixels of image data for printing generated by the electronic still camera;

FIG. 5 is a flowchart showing the flow of photographing, reproduction and printing of the electronic still camera according to the first embodiment;

FIG. 6 is a flowchart showing the flow of printing of the electronic still camera according to the first embodiment;

FIG. 7 schematically shows a condition in which the electronic still camera according to the first and second embodiments is connected to an external apparatus other than a printer;

FIG. 8 is a block diagram schematically showing the configuration of the electronic still camera according to the second embodiment;

FIG. 9 shows a relationship between switch setting and operation modes in the electronic still camera according to the second embodiment; and

FIG. 10 is a flowchart showing the flow of photographing, reproduction and printing of the electronic still camera according to the second embodiment.

### DESCRIPTION OF THE PREFERRED EMBODIMENTS

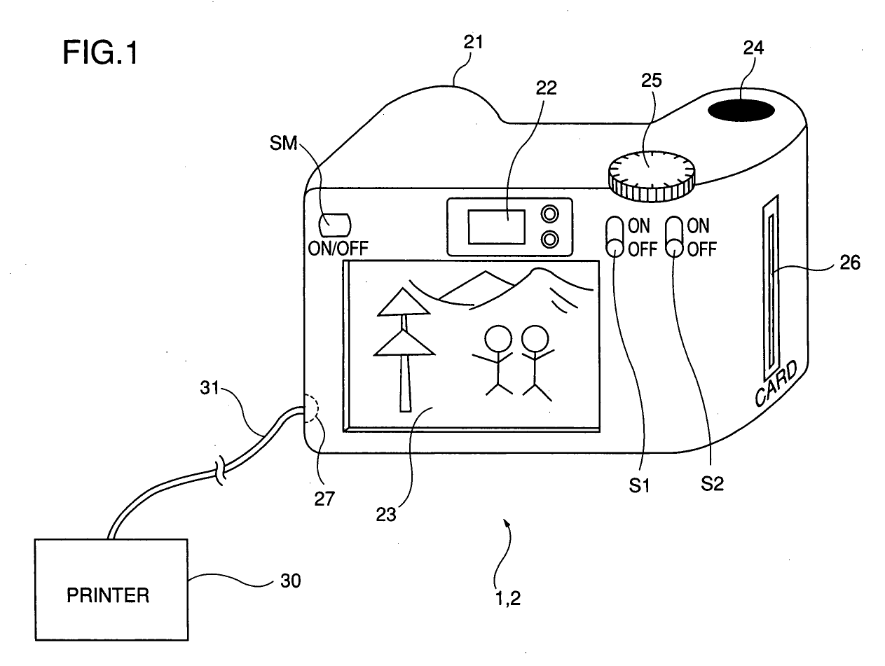

Hereinafter, embodiments of an electronic still camera (hereinafter, also referred to as mere camera) employing the present invention will be described with reference to the drawings. FIG. 1 shows the appearance of an electronic still camera 1 according to a first embodiment obliquely viewed from above from the rear. The camera 1 has a taking lens 21 on the front surface of the body, has a finder 22, a color liquid crystal display (LCD) 23, a power switch SM and two switches S1 and S2 on the back surface, has a release button 24 and a dial 25 on the top surface, has a card slot 26 on one side surface, and has on the other side surface a connector 27 to which a cable 31 is attached for connection to an external printer 30 for image printing.

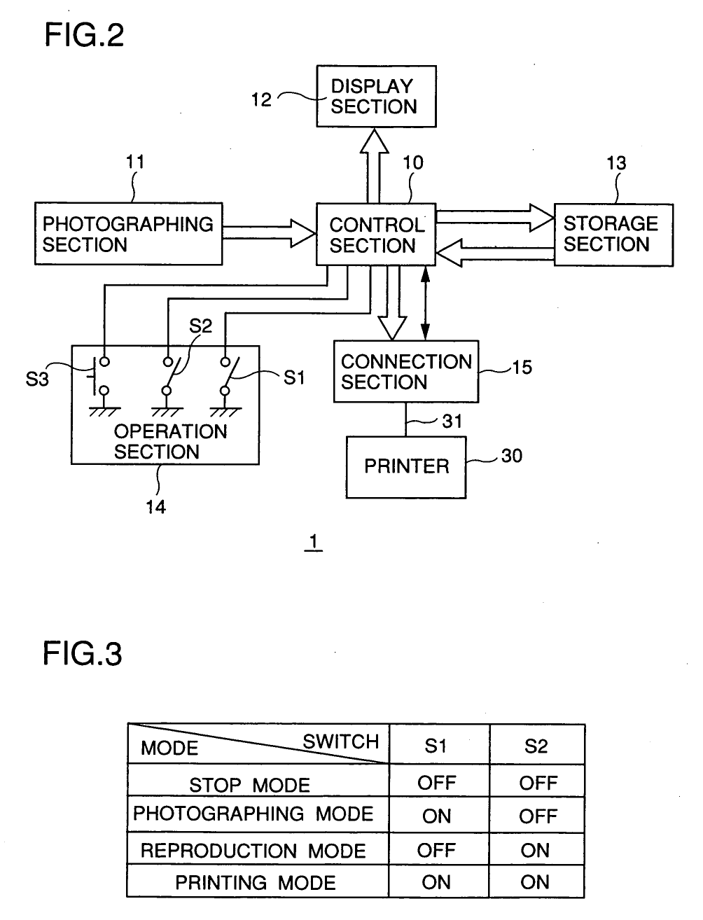

In the camera 1, light from the subject is imaged on the light receiving surface of a charge coupled device (CCD) by the taking lens 21, and photographing is electronically performed by the CCD. The taken images are stored in a memory card inserted in the card slot 26. The release button 24 has a switch S3 (see FIG. 2) which is turned on when the release button 24 is depressed.

The camera 1 has the following three operation modes: a photographing mode in which images are taken and the taken images are stored in a memory card; a reproduction mode in which the images stored in a memory card are reproduced and displayed on the LCD 23; and a printing mode in which the images stored in a memory card are transmitted to the printer 30 and printed onto paper by the printer 30. Switching among these modes is performed by the user's manual operation of the switches S1 and S2. Start of photographing in the photographing mode, change of the displayed image in the reproduction mode and start of printing in the printing mode are directed by turning on the switch S3.

For photographing, one of the following three modes can be selected: a macro mode suitable for photographing a subject at a close distance; a portrait mode suitable for normal photographing such as photographing of a person; and a sport mode suitable for photographing a fast moving subject. Switching among these modes is performed by use of the dial 25.

The printer 30 is not always connected to the camera 1 but is connected thereto when printing is performed. The user attaches the cable 31 to the connector 27 for connecting the printer 30. Various types of printers can be connected to the camera 1. The resolution of the printed images differs according to the performance of the printer.

The configuration of the camera 1 is schematically shown in FIG. 2. The camera 1 is roughly divided into a control section 10, a photographing section 11, a display section 12, a storage section 13, an operation section 14 and a connection section 15. The photographing section 11 comprises the taking lens 21, the CCD for converting light transmitted by the taking lens 21 into electric signals, an amplifier for amplifying the output signals of the CCD, an analog-to-digital (A/D) converter for converting the amplified analog signals into digital signals, and a CCD driver for driving the CCD. The display section 12 comprises the LCD 23 for displaying a reproduced image, and an LCD driver for driving the LCD 23.

The storage section 13 comprises a memory card, and a card driver for inputting and outputting images to and from the memory card. The operation section 14 includes the switch S1, the switch S2, and the switch S3 provided in the release button 24. The connection section 15 comprises the connector 27 for attaching the cable 31, and a transmitting and receiving circuit for performing transmission and reception.

The control section 10, which comprises a microcomputer, performs image processing and controls the above-described sections. Specifically, in the photographing mode, the control section 10 processes signals from the photographing section 11 to produce image signals and stores the image signals in the storage section 13, and in the reproduction mode, the control section 10 outputs image signals read out from the storage section 13 to the display section 12 to display images. In the printing mode, the control section 10 processes image signals read out from the storage section 13 to generate image data for printing and transmits the image data through the connection section 15 to the printer 30.

The control section 10 decides the operation mode from among the photographing mode, the reproduction mode and the printing mode in accordance with the setting of the switches S1 and S2 in the operation section 14. A relationship between the switches S1 and S2 and the operation modes is shown in FIG. 3. When the switches S1 and S2 are both OFF, the camera 1 is placed in a stop mode. In this mode, the control section 10 does not allow the sections of the camera 1 to operate. When the switch S1 is ON and the switch S2 is OFF, the camera 1 is placed in the photographing mode. When the switch S1 is OFF and the switch S2 is ON, the camera 1 is placed in the reproduction mode. When the switches S1 and S2 are both ON, the camera 1 is placed in the printing mode.

Prior to image printing in the printing mode, the control section 10 requests the printer 30 to transmit characteristics of the printer 30 such as the printing density and the printing size, and generates image data for printing based on the characteristic information transmitted from the printer 30. Consequently, the image data for printing transmitted to the printer 30 are responsive to the characteristics of the printer 30, and when a different type of printer is connected, different image data are generated by the control section 10.

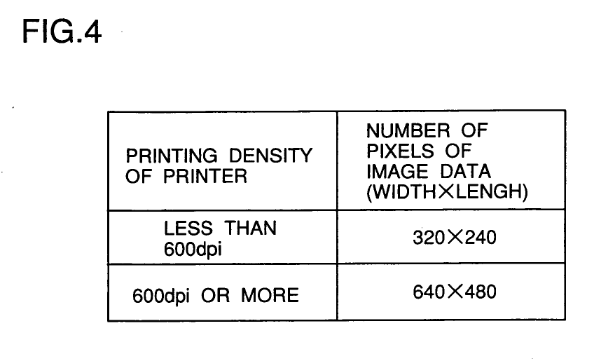

The control section 10 is capable of generating two kinds of image data: image data having a large number of pixels; and image data having a small number of pixels, and switches therebetween according to the printing density, [i.e.] i.e., the resolution of the printer 30. A concrete relationship between the printing density of the printer 30 and the image data generated by the control section 10 is shown in FIG. 4. When the printing density of the printer 30 is 600 dots per inch (dpi) or more, the control section 10 generates image data of 640 pixels wide and 480 pixels long, and when the printing density is less than 600 dpi, the control section 10 generates image data of 320 pixels wide and 240 pixels long.

Therefore, when a printer with a printing density of less than 600 dpi is connected, the amount of transmitted image data is one-fourth and the time required for the data transmission is also one-fourth compared with when a printer with a printing density of 600 dpi or more is connected.

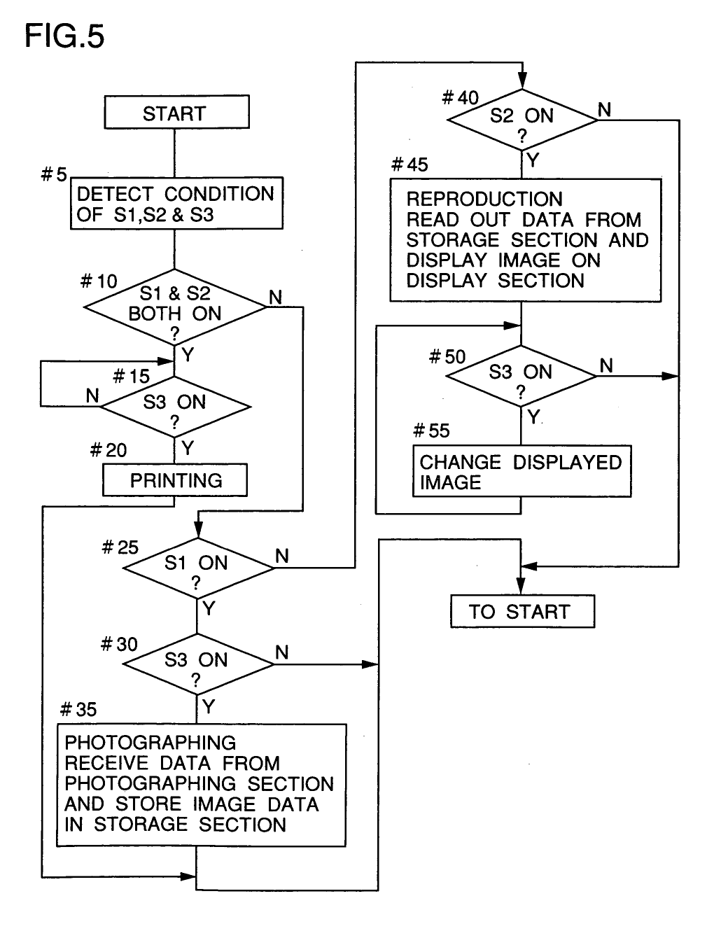

The flow of control processing performed by the control section 10 is shown in FIG. 5. First, the condition of the switches S1, S2 and S3 is detected (step #5), and it is determined whether the switches S1 and S2 are both ON or not (step #10). When the switches S1 and S2 are both ON, the process waits until the switch S3 is turned on (step #15), and when the switch S3 is turned on, processing for printing all the images in the storage section 13 is performed (step #20).

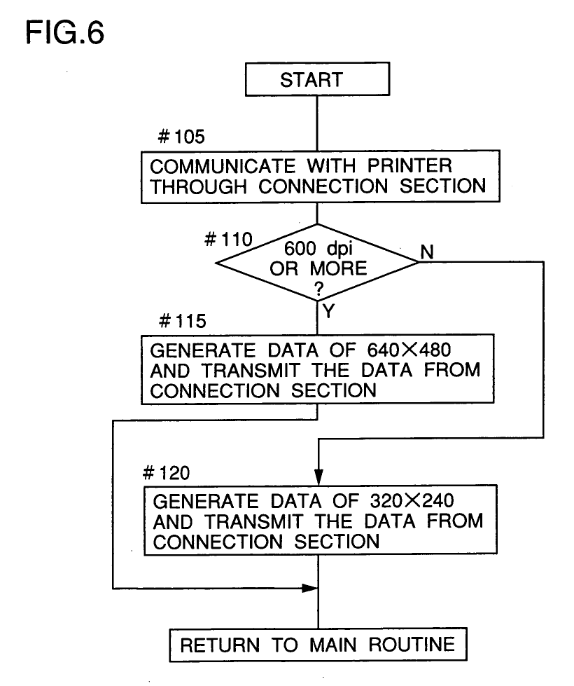

The flow of processing for printing is shown in FIG. 6. The control section 10 communicates with the printer 30 through the connection section 15 and obtains characteristic information of the printer 30 (step #105), and determines whether or not the printing density of the printer 30 is 600 dpi or more (step #110). When the printing density is 600 dpi or more, image signals are read out from the memory card and image data of 640×480 pixels are generated and outputted to the connection section 15 (step #115). When the printing density is less than 600 dpi, image signals are read out from the memory card and image data of 320×240 pixels are generated and outputted to the connection section 15 (step #120).

The control section 10 performs the generation and output of the image data successively for all the images stored in the memory card. Therefore, all the stored images are printed by one printing command issued at step #15 of FIG. 5. After the last image data are outputted to the connection section 15, the process returns to step #5 of FIG. 5.

When it is determined at step #10 that one or both of the switches S1 and S2 are OFF, it is determined whether the switch S1 is ON or not (step #25). When the switch S1 is ON, it is further determined whether the switch S3 is ON or not (step #30), and when the switch S3 is ON, photographing is performed (step #35). Specifically, image signals are produced from the output of the photographing section 11 and the produced image data are stored in the storage section 13. After photographing or when the switch S3 is OFF, the process returns to step #5.

When it is determined at step #25 that the switch S1 is OFF, it is determined whether the switch S2 is ON or not (step #40). When the switch S2 is OFF, the process returns to step #5. When the switch S2 is ON, image reproduction is performed by reading out the first image from the storage section 13 and displaying the image on the display section 12 (step #45). Then, it is determined whether the switch S3 is ON or not (step #50). When the switch S3 is turned on within a predetermined period of time, the displayed image is changed by reading out the next image from the storage section 13 and displaying the image on the display section 12 (step #55). Then, the process returns to step #50. When the switch S3 is not turned on within the predetermined period of time at step #50, the process returns to step #5.

After photographing, reproduction or printing, the control ection 10 again detects the condition of the switches S1, S2 and S3 at step #5 and performs photographing, reproduction or printing in accordance with the setting of the switches S1 and S2.

As described above, according to the electronic still camera 1, since the performance of the printer is fully delivered, the performance of the printer is not wasted even when a high-performance printer is connected. Since needless image data exceeding the performance of the printer are avoided from being transmitted, the printing efficiency improves when a low-performance printer is connected. That is, the printing time is reduced in accordance with the image quality while the quality of printed images is maintained high.

While in this embodiment, an example has been described in which the number of pixels of image data for printing has two settings according to the printing density of the printer, the number of pixels of the image data may have three or more settings by determining the printing density in smaller units. When this is done, the performance of the printer can be fully delivered irrespective of the printing density of the connected printer, so that printers of any resolution from low resolution to high resolution can be effectively used. Moreover, the time required for printing can be changed in fine increments according to the resolution of the image to be printed.

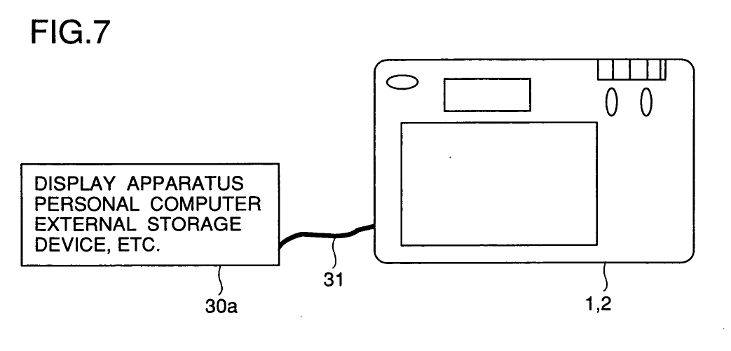

The electronic still camera 1 may be connected to an external display apparatus so that images are displayed on the external display apparatus. In this case, by generating image data for display in accordance with the resolution of the display apparatus, the transmission of needless image data is avoided and the performance of the display apparatus is fully delivered. Moreover, the camera 1 may be connected to a personal computer to transmit the image data to the personal computer so that processing such as printing, display and image superimposition is performed by the personal computer or that the images are stored in a storage device of the personal computer. In this case, by generating image data in accordance with the characteristics of the processing performed by the personal computer, the transmission of needless image data is avoided. A condition in which the electronic still camera 1 is connected to an external apparatus 30a other than a printer is shown in FIG. 7.

A second embodiment will be described. An electronic still camera 2 of this embodiment has a similar appearance to the camera 1 of the first embodiment, and is provided with all the members shown in FIG. 1 such as the switches S1 and S2 and the connector 27. Like the camera 1, the camera 2 has the switch S3 which is turned on when the release button 24 is depressed.

The camera 2 also [have] has the three operation modes: the photographing mode in which images are taken and the taken images are stored in a memory card; the reproduction mode in which images stored in a memory card are reproduced and displayed on the LCD 23; and the printing mode in which images stored in a memory card are transmitted to the printer 30 and printed onto paper by the printer 30. Of these modes, the photographing mode and the reproduction mode are switched between by the user's manual operation of the switches S1 and S2.

Start of photographing in the photographing mode, change of the displayed image in the reproduction mode and start of printing in the printing mode are directed by turning on the switch S3. Photographing is performed in a mode selected by the dial 25 from among the above-described macro, portrait and sport modes.

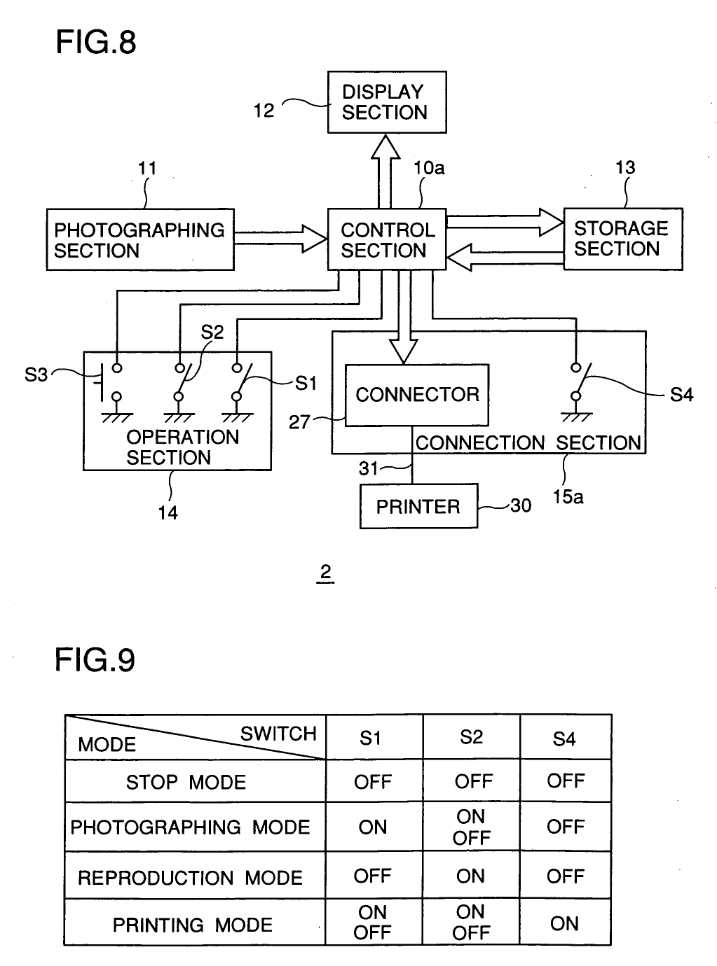

In this embodiment, like in the first embodiment, the printer 30 is not always connected to the camera 2 but is connected thereto by attaching the cable 31 to the connector 27 when printing is performed. In the connector 27, a switch S4 (see FIG. 8) is provided which is turned on when the cable 31 is attached and is turned off when the cable 31 is not attached. Switching between the printing mode and the photographing and reproduction modes is performed by turning on and off the switch S4.

The configuration of the camera 2 is schematically shown in FIG. 8. The camera 2 is roughly divided into a control section 10a, the photographing section 11, the display section 12, the storage section 13, the operation section 14 and a connection section 15a. The configuration and function of the photographing section 11, the display section 12 and the storage section 13 are the same as those of the camera 1 of the first embodiment and will not be described again. The configuration and operation of the operation section 14 are the same as those of the camera 1. However, as will be described later, the manner of mode switching performed by the control section 10a based on the condition of the switches S1 and S2 is different from that of the camera 1. The connection section 15a is different from the connection section 15 of the camera 1 in that the switch S4 is provided in addition to the connector 27 for attaching the cable 31.

The control section 10a, which comprises a microcomputer, performs image processing and controls the above-described sections. Specifically, in the photographing mode, the control section 10a processes signals from the photographing section 11 to produce image signals and stores the image signals in the storage section 13, and in the reproduction mode, the control section 10a outputs image signals read out from the storage section 13 to the display section 12 to display images. In the printing mode, the control section 10a transmits image signals read out from the recording section 13 from the connection section 15a to the printer 30 through the cable 31.

The control section 10a decides the operation mode from among the photographing mode, the reproduction mode and the printing mode in accordance with signals from the switches S1 and S2 of the operation section 14 and the switch S4 of the connection section 15a. A relationship between the switches S1, S2 and S4 and the operation modes is shown in FIG. 9. When the switch S4 is OFF, [i.e.] i.e., when the cable 31 is not attached to the connector 27, the setting of the switches S1 and S2 is enabled.

In this case, the camera 2 is placed in the stop mode when the switches S1 and S2 are both OFF. In this mode, the control section 10a does not allow the sections of the camera 2 to operate. When the switch S1 is ON, the camera 2 is placed in the photographing mode irrespective of whether the switch S2 is ON or OFF. When the switch S1 is OFF and the switch S2 is ON, the camera 2 is placed in the reproduction mode.

When the switch S4 is ON, [i.e.]—i.e., when the cable 31 is attached to the connector 27 and the printer 30 is connected to the camera 2, the camera 2 is placed in the printing mode irrespective of whether the switches S1 and S2 are ON or OFF. When the switch S4 is returned from ON to OFF, [i.e.] i.e., when the cable 31 is removed from the connector 27 and the printer 30 is disconnected from the camera 2, the setting of the switches S1 and S2 is again enabled.

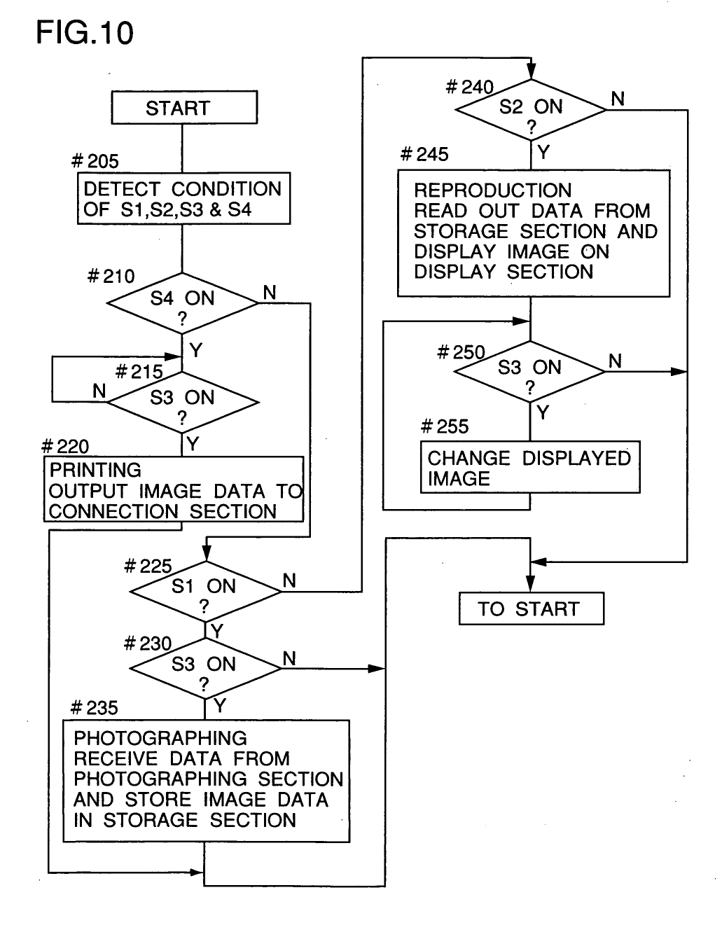

The flow of control processing performed by the control section 10a is shown in FIG. 10. First, the condition of the switches S1 to S4 is detected (step #205), and it is determined whether the switch S4 is ON or not (step #210). When the switch S4 is ON, the process waits until the switch S3 is turned on (step #215), and when the switch S3 is turned on, all the images are read out from the storage section 13 and outputted to the connection section 15a (step #220). The outputted images are received by the printer 30 through the cable 31 and printed onto paper. Then, the process returns to step #5.

When it is determined at step #210 that the switch S4 is OFF, it is determined whether the switch S1 is ON or not (step #225). When the switch S1 is ON, it is further determined whether the switch S3 is ON or not (step #230), and when the switch S3 is ON, photographing is performed (step #235). Specifically, image signals are produced from the output of the photographing section 11 and the produced image signals are stored in the storage section 13. After photographing or when the switch S3 is OFF, the process returns to step #205.

When it is determined at step #225 that the switch S1 is OFF, it is determined whether the switch S2 is ON or not (step #240). When the switch S2 is OFF, the process returns to step #205. When the switch S2 is ON, image reproduction is performed by reading out the first image from the storage section 13 and displaying the image on the display section 12 (step #245). Then, it is determined whether the switch S3 is ON or not (step #250). When the switch S3 is turned on within a predetermined period of time, the displayed image is changed by reading out the next image from the storage section 13 and displaying the image on the display section 12 (step #255). Then, the process returns to step #250. When the switch S3 is not turned on within the predetermined period of time at step #250, the process returns to step #205.

After photographing, reproduction or printing, the control section 10 again detects the condition of the switches S1 to S4 at step #205 and performs photographing, reproduction or printing in accordance with the setting of the switches. In this case, the condition of the switch S4 is also detected first so that printing is given priority over photographing and reproduction.

As described above, the electronic still camera 2 is always placed in the printing mode when the cable 31 is attached to the connector 27, and is placed in the photographing or reproduction mode in accordance with manual operation when the cable 31 is not attached to the connector 27. For this reason, in printing images, it is unnecessary for the user to be conscious of the operation mode of the camera 2 and preparation for printing is completed with a minimum operation of connecting the printer 30 to the camera. Moreover, it never occurs that the user forgets to return the camera to the mode which the camera was in before printing. Consequently, the operability improves and there is no possibility that the right moment to take a picture is missed after printing.

Further, since transmission of image signals is permitted only when the cable is attached, it is ensured that images are avoided from being transmitted under a condition where the camera is not connected to the printer, [i.e.] i.e., under a condition where transmission of images is meaningless. Consequently, it is unnecessary for the user to wait for the meaningless transmission operation to be finished, so that the operability improves, particularly, when a multiplicity of images are transmitted. Moreover, when the camera is configured so that the stored image signals are automatically erased after read out for printing, there is no possibility that the images are erased which are not actually printed because the printer is not connected.

While in this embodiment, an example has been described in which the electronic still camera is connected to a printer to perform printing, the electronic still camera 2 may be connected to an external apparatus 30a such as a personal computer as shown in FIG. 7 so as to perform not only printing but also other processing such as image display and superimposition. Moreover, a large-capacity storage device of the external apparatus may be used for storing images. In this case, the camera is also automatically placed in an operation mode to transmit images simply by attaching to the connector the cable for connection to the external apparatus.

The functions of the electronic still camera 1 of the first embodiment and the electronic still camera 2 of the second embodiment may be combined so that image data responsive to the performance of the connected external apparatus are generated and transmitted and that switching between the printing mode and the other operation modes is automatically performed in accordance with whether an external apparatus is connected or not. By doing so, an electronic still camera with high image transmission efficiency and excellent operability is achieved.

Obviously, many modifications and variations of the present invention are possible in light of the above teachings. It is therefore to be understood that within the scope of the appended claims, the invention may be practiced other than as specifically described.

1.-8. (canceled)

9. A camera being operable in a first mode in which photographing of a subject is performed and data of a taken image are stored, in a second mode in which an image of the stored data is displayed, and in a third mode in which the stored data are outputted to a printer through a detachably attached connection device and an image of the data is printed, the camera comprising:
a manual operation member;
a selector for switching between the first mode and the second mode by an operation of said manual operation member;
a connector for attaching said connection device; and
a detector for detecting whether said connection device is attached to said connector or not,
wherein when it is detected that said connection device is attached, said selector selects the third mode irrespective of condition of said manual operation member.

10. A camera as claimed in claim 9, wherein said connection device is a connection cable.

11.-15. (canceled)

16. A camera as claimed in claim 9, wherein after said connection device is detached from said connector, an operation condition of the manual operation member is detected.

17. A camera as claimed in claim 16, wherein according to the detected operation condition, the camera is brought into a first mode (photographing mode) or a second mode (reproduction mode).

18. A camera comprising:
a mode selector;
an image sensor for capturing images;
a display for displaying images;
a storage for storing captured images;
an interface for establishing a connection to an external device; and
a controller coupled to the mode selector, the image sensor, the display, the storage, and the interface, the controller being configured to:
determine a configuration of the mode selector;
detect whether a connection is established with the external device;
operate the image sensor and the storage so as to capture an image and save it to the storage when the mode selector is in a first configuration;
operate the storage and the display so as to retrieve an image from the storage and display it on the display when the mode selector is in a second configuration; and
operate the storage and the interface so as to retrieve an image from the storage and transmit it to the external device when a connection is established, regardless of the configuration of the mode selector.

19. The camera of claim 18, further comprising a shutter release, wherein the image is transmitted to the external device when the shutter release is activated.

20. The camera of claim 18, wherein the interface comprises a connector for accepting a cable connection between the camera and the external device.

21. The camera of claim 20, wherein the controller is configured to determine whether a connection is established by determining whether a cable is connected to the connector.

22. The camera of claim 20, wherein the controller returns to operating the image sensor, storage, and display responsive to the configuration of the mode selector when a previously established connection is disconnected.

23. A method of selecting an operating mode of a camera having a mode selector and an interface for establishing a connection to an external device, the method comprising:
detecting a configuration of the mode selector;
sensing whether a connection is established with the external device;
operating the camera in a first mode selected from a predetermined plurality of modes based on the detected configuration of the mode selector whenever it is sensed that a connection is not established; and
operating the camera in a second mode, not in the predetermined plurality of modes, whenever it is sensed that a connection is established, regardless of the detected configuration of the mode selector.

24. The method of claim 23, wherein the predetermined plurality of modes includes a mode for capturing images and storing images, and a mode for displaying previously captured and stored images.

25. The method of claim 23, wherein the second mode comprises transmitting a stored image to a printer.

26. The method of claim 23, wherein the second mode comprises transmitting a stored image to a personal computer.

27. The method of claim 23, wherein the second mode comprises transmitting a stored image to an external display device.

28. The method of claim 23, wherein the camera has a shutter release, the method further comprises determining whether the shutter release is activated, and the second mode comprises transmitting a stored image to the external device when the shutter release is activated.
